(19) United States
(12) Patent Application Publication
(10) Pub. No.: US 2007/0207665 A1
(43) Pub. Date: Sep. 6, 2007

(54) Cord storage device and docking device having the same

(75) Inventors: Jung-Wen Chang, Tao Yuan Shien (TW); Shih-Yun Lee, Chungho City (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/524,325

(22) Filed: Sep. 21, 2006

(30) Foreign Application Priority Data
Mar. 6, 2006 (TW) 095203658

(51) Int. Cl. H01R 13/72

(52) U.S. Cl. 439/501

(57) ABSTRACT

A docking device with cord storage function comprises a cord storage unit and a body. The body comprises a left shell and a right shell. The cord storage unit comprises a cord storage member and a base. The cord storage member has an opening with two U-turns facing inwards for storing various electronic wires and surrounds the body of the docking device. The base is set beneath the body and is fastened by both the cord storage member and the docking device.

### RELATED APPLICATIONS

The present application is based on, and claims priority from, Taiwan Application Serial Number 95203658, filed Mar. 6, 2006, the disclosure of which is hereby incorporated by reference herein in its entirety.

### BACKGROUND

1. Field of Invention

The present invention relates to a docking device. More particularly, the present invention relates to a docking device with cord storage function.

2. Description of Related Art

With the progress of technology and the demand of modern life, electronic devices like notebook computers and handheld devices have become thinner•lighter•smaller and shorter. However, electronic devices disposes various I/O ports (input/output port) such as USB (universal serial bus)•IEEE1394•PCMCIA•monitor port (D-sub for analog signal or DVI for digital signal)•microphone port•internet port and so on to increase its connectivity with a peripheral device. In recent years, card readers also have become common equipment in a notebook. To accommodate their various I/O ports, the space in the electronic device has to be large enough to place the I/O ports within; however, this requirement goes against the design trend of modern electronic devices (light, thin, short and small). Therefore, a docking device is proposed to solve the problem. A docking device has lots of I/O ports which are disposed in the electronic device originally, and communicate with the electronic device or host via another specific interface or wireless technology. For these I/O ports, the corresponding electronic cables, wires, cords or lines are necessary to transmit the signal between the peripheral device and the docking device. These corresponding electronic cables, wires, cords or lines are wound up with each other and pulling out the incorrect cable can happen easily if the cables are not put in order. Pulling out the incorrect cable may lead to serious consequence such as crash of the electronic device or loss of important data.

### SUMMARY

It is therefore an aspect of the present invention to provide a docking device with a cord storage function to store multiple electronic wires, cables or cords.

It is therefore a further aspect of the present invention to provide a docking device with a status indication function which lets a user understand the status of the docking device.

It is therefore still further an aspect of the present invention to provide a docking device with wireless transmission function for communication with a host or a server.

The invention provides a cord storage unit applicable on a docking device comprising a cord storage member and a base. The cord storage member has an opening with two U-turns facing inwards for storing wires. The wires include electronic cords and cables. The base is fastened by both the cord storage member and the docking device.

The invention also provides a docking device comprising a body and a cord storage unit. The body includes a left shell and a right shell; and contains at least one I/O port. The cord storage device comprises a cord storage member and a base. The cord storage member used to surround the docking device and has an opening with two U-turns facing inwards for storing wires. The wires include electronic cords and cables. The base is fastened by both the cord storage member and the body of the docking device.

The docking device further comprises an indication member and a wireless module; wherein the indication member is set on the surface of the body to indicate the status of the docking device and the wireless module is used to communicate with a host or a server.

Therefore, the invention provides a cord storage function to store various electronic wires; a status indication function to indicate the status of the docking device; and a wireless function to communication with a host or a server.

### BRIEF DESCRIPTION OF THE DRAWINGS

These and other features, aspects and advantages of the present invention will become better understood with regard to the following description, appended claims and accompanying drawings where:

FIG. 1 is a schematic diagram of a docking device in accordance with a preferred embodiment of the present invention;

FIG. 2 is a rear view of a docking device in accordance with a preferred embodiment of the present invention;

FIG. 3 is an exploded view of a docking device in accordance with a preferred embodiment of the present invention; and

FIG. 4 is an application diagram of a docking device in accordance with a preferred embodiment of the present invention.

### DESCRIPTION OF THE PREFERRED EMBODIMENTS

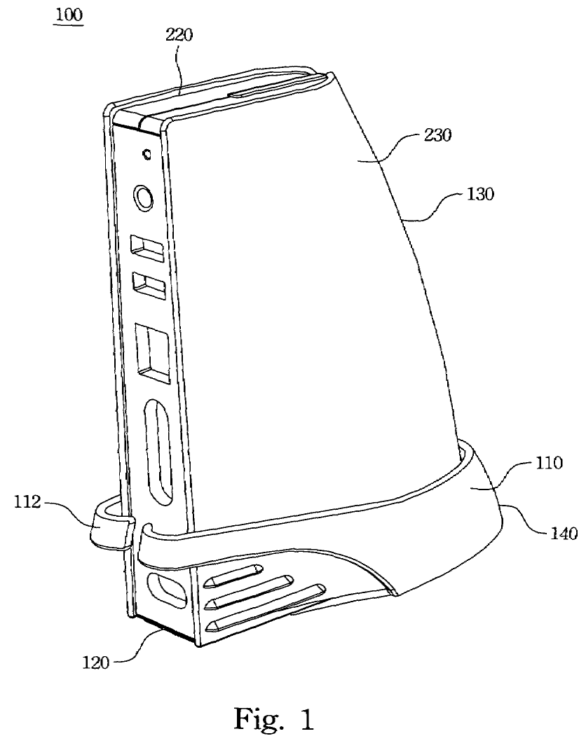

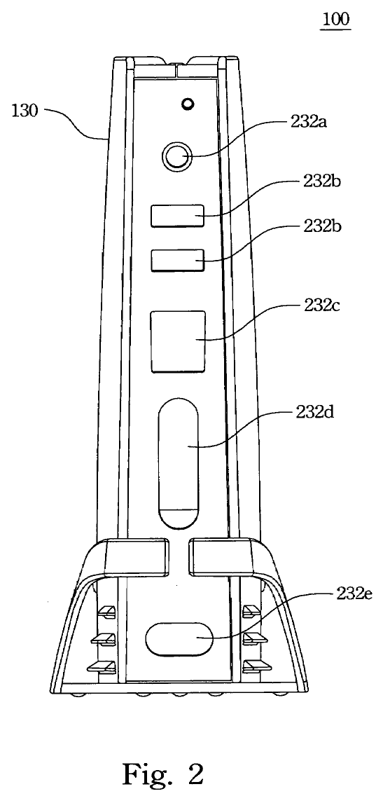

Referring to FIG. 1, FIG. 1 shows a schematic diagram of a docking device 100 in accordance with a preferred embodiment of the present invention. The docking device 100 comprises a body 130 with at least one I/O port (Input/Output port, 232a˜232e in FIG. 2) and a cord storage unit 140. The body 130 comprises a left shell 220 and a right shell 230; and the cord storage unit 140 comprises a cord storage member 110 and a base 120. The cord storage member 110 and the base 120 are hoof-shaped; and the body 130 is fin-shaped. The cord storage member 110 is set at the bottom of the docking device 100 and has an opening 112 at the rear end 112 of the cord storage member 110 wherein the opening 112 has two U-turns facing inwards for storing wires. The wires include electronic cables•cords and lines. The base 120 is set beneath the body 130 and is connected with the left shell 220•the right shell 230 and the cord storage member 110.

Refer to FIG. 2. FIG. 2 shows rear view of the docking device 100. The body 130 has multiple I/O ports 232a˜232e for various uses, for example, the I/O port 232a is for power line•the I/O port 232b is for USB (Universal Serial Bus)•I/O port 232c is for internet line or telephone line•I/O port 232d is for printer and I/O port 232e is for projector or monitor, but not limited to these I/O ports.

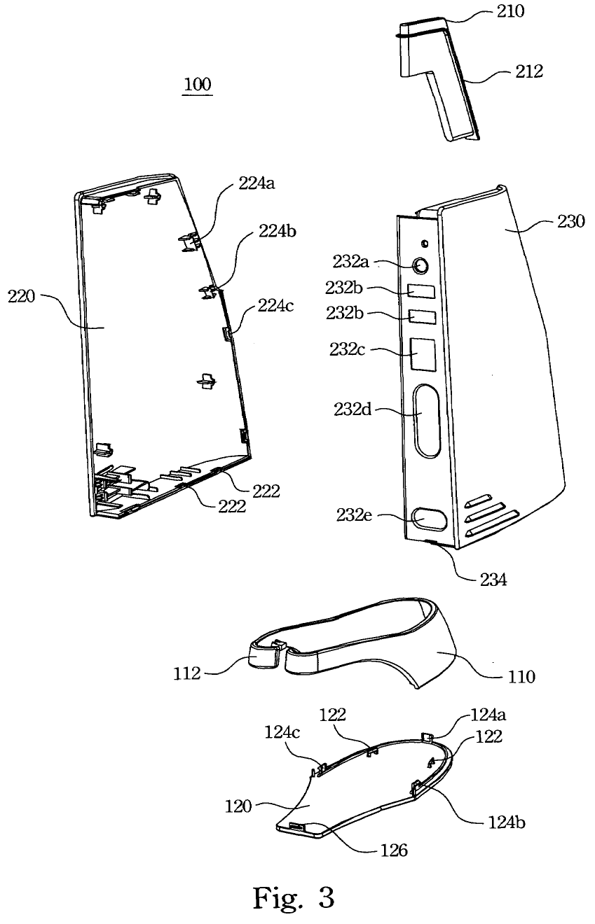

Refer to FIG. 3. FIG. 3 shows exploded view of the docking device 100. From FIG. 3, the rear side of the right shell 230 dispose the I/O ports 232a˜232e. The right shell 230 is connected with the left shell 220 by the latches 224a, 224b and 224c to form the body 130. The left shell 220 and the right shell 230 connect the base 120 via the recessions 222 together with the protrusions 122; and the recession 234 of the right shell 230 is fastened with the protrusion 126 of the base 120. The cord storage member 110 surrounds the body 130 and has an opening at the rear end 112 facing inwards with 2 U-turns for storing wires. The cord storage member 110 is connected with the base 120 via the hooks 124a•124b and 124c.

With the exception of the tangible wire, the communication between the docking device 100 and the host (a notebook, for example) could be wireless technology. Wireless technology includes infrared ray technology•blue-tooth technology•WLAN technology•UWB (Ultra WideBand) technology and so on. Using wireless technology, both ends (the docking device 100 and the host) have to dispose the corresponding transmitter and receiver. With one of the wireless modules, the docking device 100 does not have to be placed nearby of the host, just a place that wireless module can detect, which not only decreases one wire (between the host and the docking device 100) but also increase the efficiency of the space placement for the user.

For convenience, the docking device 100 further comprises an indication member 210 connected with the body 130 to show the various operation statuses of the docking device. The indication member 210 has a plate 212 with an indication device such as LEDs (not shown). The operation statuses may include power status, linking status, transmission status and wireless status. The indication device of power status lights when the power line of the docking device 100 is plugged in and closes when the power line is pulled out; the indication device of linking status lights when at least one peripheral device is inserted into the docking device 100 and closes when all the peripheral devices are pulled out; the indication device of the transmission status lights when the docking device 100 is receiving or transmitting data from/to at least one peripheral device and closes when all the transmission is finished or stopped; the indication device of the wireless status lights when the communication between the docking device 100 and the host is established via wireless technology and closes when the communication is terminated.

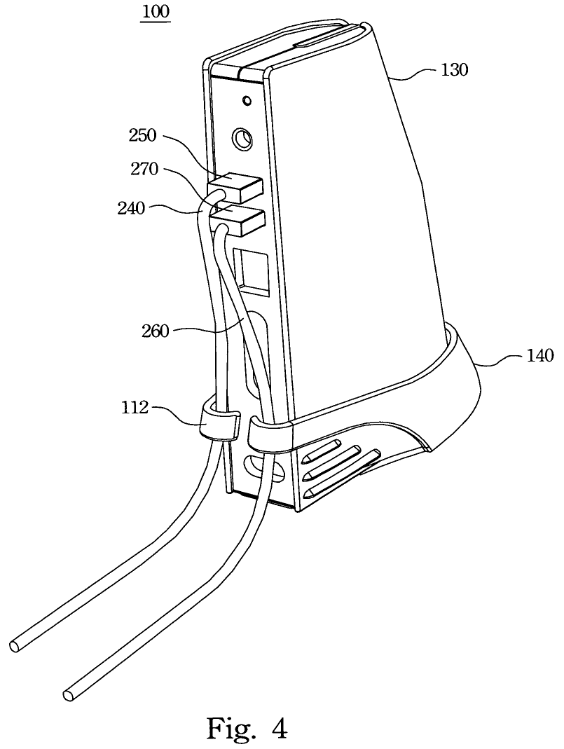

Refer to FIG. 4. FIG. 4 shows an application diagram of the docking device 100. A USB peripheral device such as a DSC (digital still camera)•DV (digital video)•external CDROM is inserted into the I/O ports 232b of the docking device 100 via the I/O wires 240 and 260. The end of the I/O wires 240 and 260 is an I/O contact area 250 and 270. The I/O wires 240 and 260 are stored by the opening of the cord storage unit 140. Therefore, with the indication member 10 and wireless module, it is convenient for a user to use and place the docking device 100 anywhere; with the cord storage unit 140, it is convenient for a user to put the wires in order which decreases the probability of the incorrect wire being pulled out.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A cord storage unit applicable on a docking device, comprising
a cord storage member with an opening facing inwards; and
a base fastened by both the cord storage member and the docking device.

2. The cord storage as claimed in claim 1, wherein the cord storage member is hoof-shaped.

3. The cord storage as claimed in claim 1, wherein the base is a plate of hoof-shaped.

4. A docking device, comprising:
a body with at least one I/O port having:
a left shell; and
a right shell fastened with the left shell; and
a cord storage unit, including:
a cord storage member with an opening facing inwards; and
a base fastened by both the cord storage member and the docking device.

5. The docking device as claimed in claim 4, wherein the cord storage member is hoof-shaped.

6. The docking device as claimed in claim 4, wherein the base is a plate of hoof-shaped.

7. The docking device as claimed in claim 4, wherein the body is fin-shaped.

8. The docking device as claimed in claim 4, further comprising an indication member which is fastened with the body to indicate the power status•connection status•transmission status and wireless status.

9. The docking device as claimed in claim 8, wherein the indication member is an LED (Light Emitting Diode).

10. The docking device as claimed in claim 4, further comprising a wireless module to communicate with a host or a server.

11. The docking device as claimed in claim 10, wherein the wireless module is an infrared ray module•blue-tooth module•WLAN module or UWB module.
